(19) United States
(12) Patent Application Publication
(10) Pub. No.: US 2006/0069714 A1
(43) Pub. Date: Mar. 30, 2006

(54) System enhancement using client context information

(76) Inventors: Marion Lee Blount, Mahopac, NY (US); Veronique Perret, Saint-Blaise (CH); Apratim Purakayastha, Yorktown Heights, NY (US); Danny Lo-Tien Yeh, Irvington, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 10/936,158

(22) Filed: Sep. 8, 2004

(51) Int. Cl. G06F 15/16

(52) U.S. Cl. 709/203

(57) ABSTRACT

A system and method responsive to context information includes a client device and a module associated with the client device, which accesses static or dynamic context information about a condition of the client device or the environment of the client device. A collector collects context information from the at least one module. A server is accessible by the client device, receives the context information from the client device and passes the context information to a server presentation manager. The presentation manager uses the client context information to modify a normally generated response in a way that adapts a response sent to the client device in accordance with the context information.

### BACKGROUND

1. Technical Field

The present invention relates to network systems and more particularly to a system and method for collecting client context information, passing that client context information to a presentation management component of the web server and having the presentation management component of the web server use the client context information to improve the user's interaction with an application and improve the view on the client device generated by the web server.

2. Description of the Related Art

A web application model is typically a 3-tier model. A user views and interacts with a client tier. A middle tier includes application logic and back-end data access components. A third tier includes the back-end data sources, legacy system, web services that serve as the data sources and data destinations of the middle tier's data access components.

The main client tier element is a web browser. The web browser is capable of rendering and generating hypertext documents. The browser interacts with the middle tier with a standardized hypertext transfer protocol (HTTP). Browser rendering is based on standardized markup languages like the hypertext markup language (HTML). Both HTTP and HTML are W3C standards. Over time, both HTTP and HTML have been extended in order to provide a richer interaction between the client (using a browser) and the web server application. XHTML, DHTML, Java™ Server Pages, Active Server Pages, Java™ Script, and applets are just some of the things that have been deployed to enrich the interaction between browsers and web server applications.

The main middle tier element, the web server, includes the web applications and web application services. Web applications services are functions that are generally needed in support of web applications, so shared scalable implementations of those web application services are maintained at the middle tier.

In the early days of the web, the markup generated by a web application was sent directly to the web browser on the client device. However, web servers have become more sophisticated and have evolved to the point where the web page sent to the client device's web browser is generally generated by more than one independent markup source. There is a web application service, which may be called a server presentation manager, which takes markup from multiple applications, or web services and aggregate them into a single web page. There is not a single version of the server presentation manager; each server presentation manager is specialized according to the markup fragment package.

A server presentation manager that specializes in iframes takes markup from multiple web services packaged as iframes and aggregates the iframes into a single web page. A server presentation manager that specializes in portlet fragments takes the markup generated by multiple portlets and aggregates them into a single web page.

A user-agent field of an HTTP request header may describe a browser that generated the request. The HTTP 1.0 standard may be seen in RFC 1945; and the HTTP 1.1 standard may be seen in RFC 2068. These RFC's can be found at http://www.w3.org/Protocols/rfc2068/rfc2068. There is generally a mapping between a type of browser and a type of client device. PC browsers generally do not run on handheld client devices. The most prevalent user-agent header value on the web is “Microsoft Internet Explorer™” and designates a computer device with a normal screen size. A browser on a Pocket PC device has a user-agent header value of “Windows CE™.” Since a web page designed for a full-screen PC displays very poorly on a handheld computer screen, some server presentation managers generate an alternate set of markup for small screen devices.

The server presentation manager essentially uses the value of the HTTP request header user-agent field to determine which set of markup to send to the device. This is an adaptation based on a static value.

Composite Capabilities/Preference Profiles (CC/PP) is a W3C recommendation (http://www.w3.org/TR/2004/REC-CCPP-struct-vocab-20040115/) that has the goal of providing a way for device characteristics and user preferences to be passed via RDF metadata on HTTP messages. CC/PP provides the ability to specify a very broad set of information. Examples include version numbers of applications, screen dimensions, and the amount of memory in the device. A main characteristic of this data is that it is static; that is, the data changes very, very slowly, if at all.

In the paper “Applying CC/PP to User's Environmental Information for Web Service Customization,” by Wataru Okada, Fumihiro Kato, Kazuhiro Kitagawa, and Tatsuya Hagino, presented as a poster at the World Wide Web Conference in 2001, a system is presented for gathering context at the client device and forwarding the information to the web server. At the web server, the information is presented to applications through the cgi-bin interface. The context information has to be passed to all applications because there is no context repository on the web server. The complete context of the client device must be passed on each request since there is no repository at the web server.

### SUMMARY

Present embodiments improve on the related art by providing a way to do presentation adaptation based on both static and dynamic information. If context data are forwarded to a server presentation manager, the presentation manager responds to the client device by allowing dynamic, as well as static, information to be passed to the server presentation manager.

The present embodiments advantageously store the client context information at the server, so that it is available to the server container services as well as web applications. The client context information may be used more efficiently since only new values need to be sent when there are changes. The server presentation manager does not process incoming requests in the prior art, so it would not be able to access client context information (as in the Wataru Okada, et. al. system).

A system and method responsive to context information includes a client device and a module associated with the client device, which accesses static or dynamic context information about a condition of the client device or the environment of the client device. A collector collects context information from the at least one module. A server is accessible by the client device, receives the context information from the client device and passes the context information to a server presentation manager. The presentation manager uses the client context information to modify a normally generated response in a way that adapts a response sent to the client device in accordance with the context information.

A system responsive to context information includes a client device and at least one context information source, which has static or dynamic context information about conditions of the client device or the environment of the client device. A web server is accessible by the client device, and includes a repository for storing the context information. A web application has access the context information in the repository, and uses the client context information to modify a normally generated response in a way that adapts a response sent to the client device in accordance with the context information.

A method for responding to a user request, includes the steps of receiving the user request from the client device, along with client context information including static and dynamic context information about the client device and/or the environment of the client device and responding to the request provided to a server by employing the context information about the client device to modify a normally generated response in a way that adapts an individual response sent to the client device.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing a client device connected by a network to a web application server in accordance with one embodiment;

FIG. 2 is a block diagram showing a client device connected by a network to a portal server in accordance with one embodiment;

FIG. 3 is a block diagram showing client device components including context collectors in accordance with one illustrative embodiment; and

FIG. 4 is a block diagram showing server side components including portal services in accordance with one illustrative embodiment.

### DETAILED DESCRIPTION OF PREFERRED EMBODIMENTS

Exemplary embodiments of the present disclosure are illustratively described in terms of a portal server as a web server and a portal aggregator as a server presentation manager. These embodiments apply to all current and future server presentation managers in which the presentation manager aggregates markup that was generated from multiple independent entities.

Client context information is any information about the client device or information about the environment of the client device. The context information may be static, or it may be dynamic. An example of static context information is a device profile, which includes information on all of the hardware and software resources on the client device. Examples of dynamic context information are the number of persons around who are in viewing distance of the device screen, the temperature, and the GPS location of the device.

One aspect of the present invention is that client context information can be gathered by a component on the client device. The context information is gathered from sensors and devices attached to the client device, from sensors and devices that are a part of the client device, through software calls, and from networked services. An example of context information gathered by a local software call is the size of the browser window, which can be given by an application programming interface (API) call of the client device's windowing system. If the client device has network connections, the client device can get context information from the networked context servers.

In accordance with embodiments of the present disclosure, the client context information gathered by the client device is passed to the web application server where it is made available to the server presentation manager component and to the web applications. The presentation manager uses the client context information to make adaptations to the web page sent to the client device. The web applications use the client context information to adapt a markup fragment that the application generates. The adaptations make the web page more responsive to the client device's current context. Since the user is also in the same vicinity as the device, the web page displayed is also more responsive to the user's current context. This has the overall effect of improving the user's experience of accessing the web application server and using the web applications on the web application server.

For example, if the context information indicates that persons are within viewing distance of the device screen, the presentation manager may display, for example, a banking portlet in minimized mode instead of a normal view mode. If the client context information indicates that the client's location is at home, it may display pointers to a set of personal web applications, instead of the default main web page including work-related web applications. Thus, the web application server adapts to the current context of the device and the user.

The exemplary embodiments of the present invention are particularly applicable when the client device browser and the web application server are both on the same client device and also when there is a network connection between the client device and the web application server.

It should be understood that the context information may include various information, which can be collected with respect to a client device. Each client device or set of client devices may be subject to same or different conditions. These client devices may be lumped together and responsive to a single condition or set of conditions either individually or as a group. Exemplary embodiments described herein described specific examples of context information that can be collected. One skilled in the art would understand that variations and additions may be made with respect to these examples.

It should be understood that the elements shown in the FIGS. may be implemented in various forms of hardware, software or combinations thereof. Preferably, these elements are implemented in a combination of hardware and software on one or more appropriately programmed general-purpose digital computers having a processor and memory and input/output interfaces.

The exemplary embodiments of the present invention will illustratively be described for a portal server as a web server and a portal server aggregator as a server presentation manager. This disclosure should not be construed as limited to this illustrative description. Rather, this description is an example of one particular implementation.

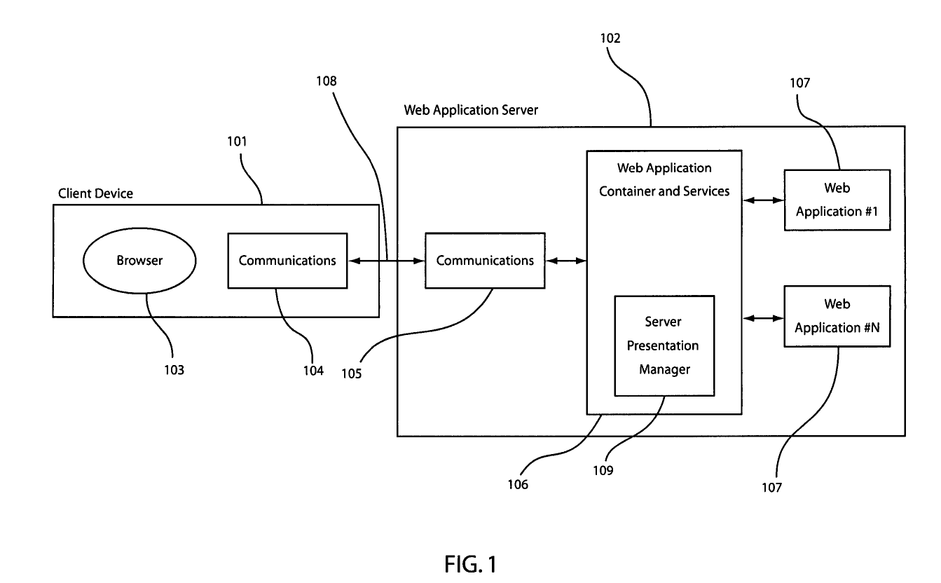

Referring now to the drawings in which like numerals represent the same or similar elements and initially to FIG. 1, a client device 101 is connected via a computer network 108 to a web server 102. Since the computer network 108 is a logical representation of multiple physical networks, both the client device and the web server connect to their local portion of the network with communications components 104 and 105. A browser 103 on the client device 101 is one way for the user to view and interact with web applications 107. A web application server 102 provides a number of services and functions for applications and application developers in a component labeled Web Application Container and Services 106. One of the services focused on herein includes a server presentation manager 109.

A portal is a web application that serves as a single entry point for a number of applications and services. Portals have become a popular way to give groups of users access to common services and applications. Instead of managing access on a per person basis for a number of employee applications and services, a company can place the applications and services on a single portal and manage access to a single entity. Instead of maintaining links and icons for many applications and services, an employee can maintain one link to the employee portal.

Each of the applications or services is implemented as a web application called a portlet. As web applications, portlets and servlets are similar. The Portlet API has request objects and response objects; programmers can analyze requests and generate responses using those APIs. Other parts of the Portlet API allow programmers to maintain user-specific information for a portlet, and provide means for the portal to perform lifecycle management of the portlet. Application developers are not limited to the Portlet API; they may use, e.g., other services and APIs commonly available to application programmers.

Portals provide users ways of managing access to a plurality of portlets. Portals have per-user configuration information which gives users the ability to group portlets in hierarchical groups. Portals also provide means for navigating among the groups and subgroups. At the lowest level is a portal page, which includes multiple portlets in a single page. The portal aggregator has the responsibility of displaying a portal page. The markup generated by a portlet is not sent directly to the browser, but, instead is sent to the portal aggregator.

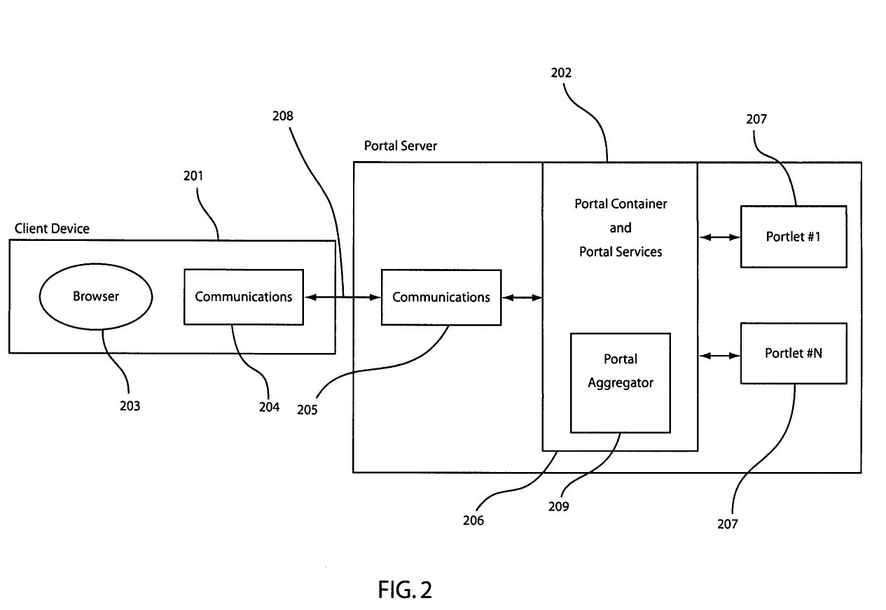

Referring to FIG. 2, a client device 201 and a portal server 202 are connected by a computer network 208. The computer network 208 may include one or more physical computer networks that are interconnected. The physical networks may be of various types (local area networks, wide area network, wired networks, wireless networks, etc.) and of various technologies.

The Internet Protocol (IP) may be the link level protocol, although other protocols may also be employed. A higher-level protocol used by the client device 201 and the portal server 202 is the Hyper Text Transport Protocol (HTTP). Communications function 204 connects the client device 201 to a computer network 208. Communications function 205 connects the portal server 202 to the computer network 208. The networks connected in 208 may be different since the client device 201 and the portal server 202 may physically connect to different networks.

A main application on the client device needed to access the portal server 202 is a web browser 203. The web browser 203 interacts with the portal server 202 preferably using the HTTP protocol and is capable of rendering web pages generated according to a number of markup standards. Example markup languages include, for example, HTML, DHTML and XHTML. Wireless Application Protocol (WAP) has been developed to address the resource issues that client devices like handhelds and cell phones have on wireless networks. WAP has a protocol stack that includes both transport and markup. WAP browsers may serve as web browsers.

The client device 201 may include any computer on which a browser can execute and which is compatible with the protocol and markup. Client devices may include personal computers, mobile computers, handheld devices, other servers, etc.

Each portlet 207 corresponds to an application or service. Instead of deploying the application or service to each client device, a portal is a centralized server that permits the user access to applications and services through a browser. Portal server 202 has a number of portal services, which make it possible to provide, for example, hundreds and thousands of portlets 207 to hundreds and thousands of users (201).

One example of a service includes an authentication service for providing secure access to the portal. A user can subscribe to a subset of the portlets 207 and the user can also decide how to group the portlets 207 in a number of web pages. A portal web page, for example, includes a number of portlets 207. This mapping can be unique for each user. Maintaining the correlation between portlets, the user and the user's portlet grouping may even be performed by some of the portal services.

A user can customize a portlet by selecting application preferences and applications parameter values. For example, a stock tracking portlet may provide continuous update on the stock price of a number of stocks. The stock symbols may be application parameters. Each user can select his or her stock list. When User A accesses the stock tracking portlet, it is instantiated with his stock list. When User B accesses the stock tracking portlet, it is instantiated with his stock list.

Portal container and portal services 206 includes the set of services used by the portal to maintain and manage access to portlets 207.

The markup generated by portlets 207 is not sent directly to the browser 203 on the client device 201. Since there can be multiple portlets 207 in a web page, the markup from each portlet is aggregated by a portal service called a portal aggregator 209. In addition to the markup from multiple portlets, the aggregator 209 may also add in portal labels and portal navigation components.

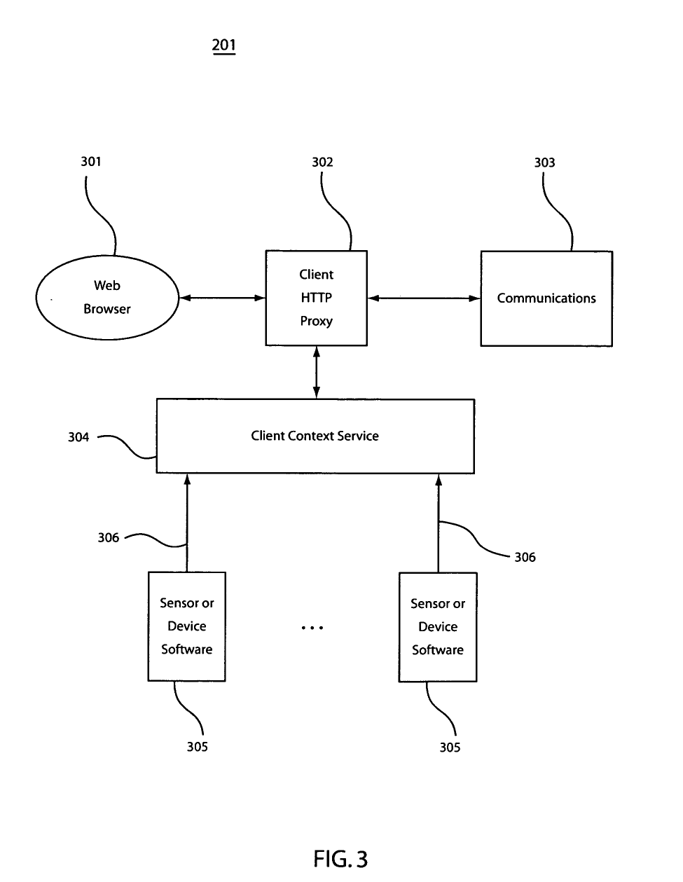

Referring to FIG. 3, client device components that compose the client side of some of the embodiments are illustratively shown. There are one or more sensors 305 that can be attached to or embedded in client devices 201 that provide information about the context of the client device 201 and users. There are a number of peripheral devices 305 that can be attached to busses, ports, and card slots 306 of the client device 201 that can provide information about the context of the client device 201 and the users near the client device. This is applicable for all categories of client devices, from a computer server to a handheld client device.

For example, global positioning systems (GPS) devices can be attached to handheld client devices. Motion detectors, light sensors, sound detectors, infrared sensors, temperature sensors are just some of the sensors and peripheral devices that are available and may be employed by the present embodiments to provide environmental feedback of the surrounding relative to client device 201. It is fully contemplated that more kinds and varieties of sensors and peripheral devices will be available in the future as the deceasing cost of electronics makes it cost effective to deploy such devices.

Sensor and peripheral device software 305 on the client device 201 enable applications on the client device 201 to interact with the sensors and peripheral devices 305. These devices 305 may include software or hardware interfaces 306 through which one can programmatically or otherwise acquire the sensor data and peripheral device data. A client context service 304 uses these programmatic interfaces 306 to acquire and store client context information received from devices 305 or running on client device 201. Depending on the source of the context data, the client context service 304 makes the calls for new data values at some periodicity, which may include continuously or intermittently monitoring devices 305 or system 201.

Another client device component may include a client HTTP proxy 302. In the book Web Proxy Servers by Ari Luotonen (Prentice Hall, 1997 p. 4), a proxy server is defined as “an intermediary server that accepts requests from clients and forwards them to other proxy servers, the origin server, or services the request . . . A proxy acts both as a server as well as a client: the proxy is a server to the client connecting to it, and a client to the servers that it connects to.”

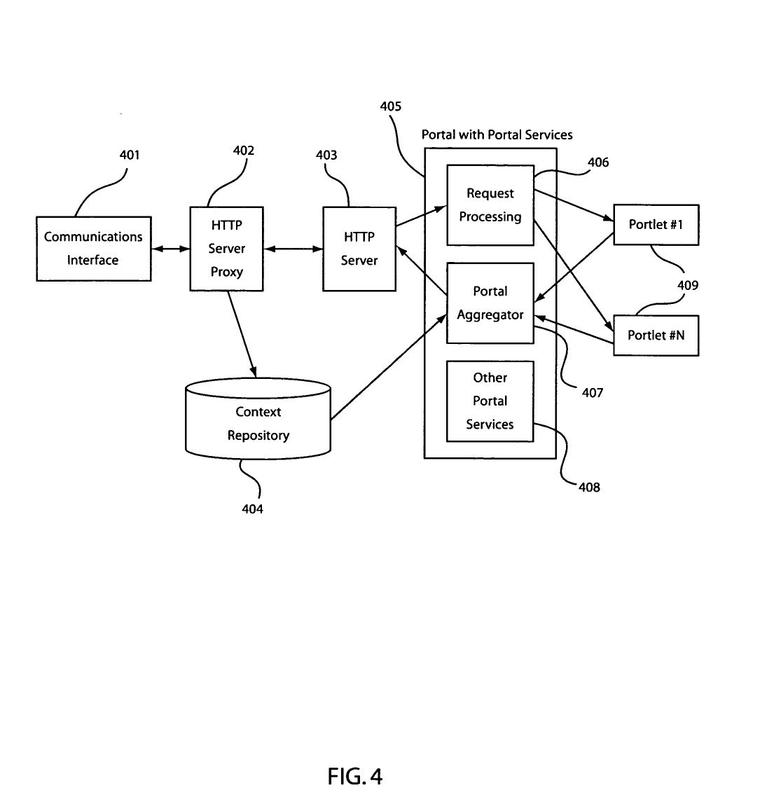

The HTTP proxy 302 is an intermediary in an HTTP flow. HTTP proxy 302 takes HTTP messages that are destined to the client device's web browser 301 and forwards those HTTP messages onto the client device's web browser unchanged. For HTTP messages that flow from the client device's web browser to the portal, the client HTTP proxy 302 calls the client context service 304 to get new client context data values. Service 304 adds this information to the HTTP message as headers and then forwards the HTTP message onto a portal server (405 in FIG. 4) through communication network 303.

The client HTTP proxy 302 does not need to call the client context service 304 for every HTTP message that is flowing from the client device's browser 301 to the portal server 405. If there are no changes in the client context information, no new client context information needs to be sent in the HTTP headers to the portal server 405.

Referring to FIG. 4, the portal server 405 is connected to a network through a communications interface 401. A portal server HTTP proxy 402 examines all of the HTTP messages that flow to portal server 405. Proxy 402 examines the message headers for client context information that is being passed from the client device (201). If any client context information is present in the HTTP message, it is extracted and placed in the portal server's context repository 404. The HTTP proxy 402 then forwards the HTTP message onto the HTTP server 403 or a HTTP processing unit 406 of the portal server 405 for regular processing.

The portal 405 is shown in FIG. 4 with a few illustrative portal services. Other portal service are contemplated and expected. Other portal services 408 are representative of the portal services other than the request processing service 406 and a portal aggregation services 407, which may be employed.

The request processing element 406 processes the request generated by the user through the browser (301) on the client device (201). The request may have been generated as a result of user interaction with a portal-level link (like a navigation selection) or a portlet-level link. In either case, affected portlets 409 and the portal 405 generate response markup fragments. The response markup fragments are passed to the portal aggregator 407 to generate the response web page or other data structure. At this point, the portal aggregator 407 accesses the context repository 404 to obtain client context information for the client device associated with the response web page. The portal aggregator 407 may perform a number of adaptations based on the client context information.

For example, the portal aggregator 407 may determine that the size of the browser window on the client device (201) has been changed to a size that makes the rendered portlets look awkward. An adaptation may be to render the page with all of the portlets minimized except the portlet from which the original request was generated. The size of the browser window may be available through a window system API call on most client devices. The client context service (304) can use this call to obtain that client context information.

In one example, a user may have a set of portlets 409 that are used from work and a set of portlets 409 that are used from home. The user may segregate these portlets on different portal pages. If the portal aggregator 407 determines that the user is located at work, then the front portal page rendered may include the at-work portlets. If the portal aggregator 407 determines the user is located at home, then the front portal page rendered may include the at-home portlets. A sensor (305), such as a GPS device attached to the client device (201) can give current GPS reading, for example.

The adaptations described as well as other adaptations may be implemented and supported by the portal server 405. The portal server 405 may have certain defaults that match values of context information variables with specific adaptations. Thus, the actions of the portal aggregator 407 may include determining the set of adaptations enabled for the specific client device, determining the adaptations that apply for the given set of client context information, performing the adaptations, etc.

The user may be given a user interface to override defaults or even to define combinations of client context information that enable an adaptation.

A portlet instance associated with a client device may also access the context repository 404. In this way, the portlet 409 may directly adapt its output to the current client context. In one example, if the client context information indicates that the user is not alone while viewing the browser screen, sensitive information will not be displayed by the portlet. For example, a banking portlet could use an adaptation to ensure user privacy and security.

Other illustrative examples of applications for the present embodiments may include, for example, responding to weather/temperature changes by generating an adaptation, which displays a weather report for the locale, measuring noise levels and increasing the speaker volume for an application, or any other feedback mechanism which works as a result of the client device context.

Having described preferred embodiments of a system enhancement using client context information (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A system responsive to context information, comprising:
a client device;
at least one module associated with the client device, which accesses static or dynamic context information about a condition of the client device or the environment of the client device;
a collector which collects context information from the at least one module; and
a server accessible by the client device, which receives the context information from the client device and passes the context information to a server presentation manager, which uses the client context information to modify a normally generated response in a way that adapts a response sent to the client device in accordance with the context information.

2. The system as recited in claim 1, wherein the server includes a web server and the client device includes an interface browser such that the interface browser and the web server both run on the client device.

3. The system as recited in claim 1, wherein the server includes a portal server and the server presentation manager includes a portal aggregator.

4. The system as recited in claim 1, wherein the context information includes static client context information and dynamic client context information.

5. The system as recited in claim 1, wherein the context information is passed from the client device to the server over a same interaction protocol normally used by a client device, which does not collect context information.

6. The system as recited in claim 1, wherein the client device sends the context information periodically.

7. The system as recited in claim 1, wherein the client device sends the context information when there is a change in the context information at the client device.

8. The system as recited in claim 1, wherein the server stores the context information in a repository and maintains an association between the client device the client device's context information such that the context information in the repository includes up to date context information.

9. The system as recited in claim 1, wherein the context information includes externally measured environmental conditions.

10. A system responsive to context information, comprising:
a client device;
at least one context information source, which has static or dynamic context information about conditions of the client device or the environment of the client device;
a web server accessible by the client device, which includes a repository for storing the context information; and
a web application which access the context information in the repository, and use the client context information to modify a normally generated response in a way that adapts a response sent to the client device in accordance with the context information.

11. The system as recited in claim 10, wherein the client device includes an interface browser such that the interface browser and the web server both run on the client device.

12. The system as recited in claim 10, wherein the web server includes a portal server and the portal server includes a portal aggregator, which handles a response in accordance with the context information.

13. The system as recited in claim 10, wherein the context information is passed from the client device to the web server over a same interaction protocol normally used by a client device, which does not collect context information.

14. The system as recited in claim 10, wherein the client device sends the context information periodically.

15. The system as recited in claim 10, wherein the client device sends the context information when there is a change in the context information at the client device.

16. The system as recited in claim 10, wherein the repository maintains an association between the client device and the client device's context information such that the context information in the repository includes up to date context information.

17. The system as recited in claim 10, wherein the context information includes externally measured environmental conditions.

18. A method for responding to a user request, comprising the steps of:
receiving the user request from the client device, along with client context information including static and dynamic context information about the client device and/or the environment of the client device; and
responding to the request provided to a server by employing the context information about the client device to modify a normally generated response in a way that adapts an individual response sent to the client device.

19. The method as recited in claim 18, wherein the context information includes externally measured environmental conditions.

20. The method as recited in claim 18, wherein the server includes a portal server and the portal server includes a portal aggregator, and the method further comprises the step of handling a response to the request in accordance with the context information by determining a set of portlets suitable for generating the response.

21. The method as recited in claim 18, wherein the client device sends the context information periodically.

22. The method as recited in claim 18, wherein the client device sends the context information when there is a change in the context information at the client device.

23. A program storage device readable by machine, tangibly embodying a program of instructions executable by the machine to perform method steps for responding to a user request, which includes context information as recited in claim 18.
